(19) United States
(12) Patent Application Publication
(10) Pub. No.: US 2025/0014303 A1
(43) Pub. Date: Jan. 9, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: YUKI TAKEDA, TOKYO (JP); HAJIME WAKABAYASHI, TOKYO (JP); RYOSUKE MURATA, TOKYO (JP); DANIEL MAKOTO TOKUNAGA, TOKYO (JP); HARUKA FUJISAWA, TOKYO (JP)

(21) Appl. No.: 18/710,839

(22) PCT Filed: Nov. 14, 2022
(86) PCT No.: PCT/JP2022/042244

§ 371 Date: May 16, 2024

(30) Foreign Application Priority Data
Nov. 24, 2021 (JP) 2021-190533

(51) Int. Cl. G06V 10/25; G06T 19/00

(52) U.S. Cl. CPC G06V 10/25; G06T 19/006; G06V 2201/07

(57) ABSTRACT

An information processing device includes: a region specifying unit that specifies a plurality of regions each including each of a plurality of objects detected from an image; and an allocation unit that allocates specific processing to be performed on each of the plurality of regions to a plurality of devices.

### TECHNICAL FIELD

The present technology relates to an information processing device, an information processing method, and a program.

### BACKGROUND ART

In an optical see-through augmented reality (AR), a video see-through AR, AR in a mobile terminal such as a smartphone, or the like, there is a technology of displaying a virtual object according to attribute information of an object existing in a real space. The attribute information is semantic information associated with an object, such as a name, a meaning, and an affordance of the object, and a relationship between a plurality of objects. In order to display the virtual object according to the attribute information of the object, it is necessary to estimate the attribute information of the object existing in the real space. As a method of estimating the attribute information of the object, for example, there is an algorithm of estimating the attribute information from the camera image. The algorithm specifies a region in units of pixels from an input camera image, and estimates attribute information such as a name and a meaning of an object and an affordance. However, an algorithm for estimating attribute information is developing, and a calculation amount tends to increase with improvement in accuracy. Therefore, a long processing time is required to estimate the attribute information.

Therefore, a technique has been proposed in which a camera image is divided into a plurality of regions, and a recognizer is selected on the basis of an attribute of each of the divided regions to detect an object, thereby reducing the overall processing amount (Patent Document 1).

### CITATION LIST

### Patent Document

Patent Document 1: Japanese Patent Application Laid-Open No. 2014-99055

### SUMMARY OF THE INVENTION

### Problems to be Solved by the Invention

In the technology described in Patent Document 1, there is also a problem that the processing may not be completed within the time of the frame rate of XR in a case where there are many recognizers to be finally operated.

The present technology has been made in view of such a point, and an object thereof is to provide an information processing device, an information processing method, and a program capable of efficiently executing processing by allocating specific processing for an image to an appropriate device.

### Solutions to Problems

In order to solve the above-described problem, a first technology is an information processing device including: a region specifying unit that specifies a plurality of regions each including each of a plurality of objects detected from an image; and an allocation unit that allocates specific processing to be performed on each of the plurality of regions to a plurality of devices.

Furthermore, a second technology is an information processing method including: specifying a plurality of regions each including each of a plurality of objects detected from an image; and allocating specific processing to be performed on each of the plurality of regions to a plurality of devices.

Furthermore, a third technology is a program for causing a computer to execute an information processing method including: specifying a plurality of regions each including each of a plurality of objects detected from an image; and allocating specific processing to be performed on each of the plurality of regions to a plurality of devices.

### BRIEF DESCRIPTION OF DRAWINGS

FIG. 1 is a block diagram illustrating a configuration of an AR system 10.

FIG. 2 is a block diagram illustrating a configuration of a terminal device 100.

FIG. 3 is a block diagram illustrating a configuration of an information processing device 200.

FIG. 4 is a block diagram illustrating a configuration of a server device 300.

FIG. 5 is a diagram illustrating an example of an image to be processed.

FIG. 6 is a flowchart illustrating overall processing in the information processing device 200.

FIG. 7 is a flowchart illustrating overall processing in the information processing device 200.

FIG. 8 is a diagram illustrating regions specified in an image.

FIG. 9 is a flowchart illustrating processing of a priority determination unit 205.

FIG. 10 is a flowchart illustrating processing of an allocation unit 206.

### MODE FOR CARRYING OUT THE INVENTION

Hereinafter, an embodiment of the present technology will be described with reference to the drawings. Note that the description will be made in the following order.
<1. First Embodiment>
[1-1. Configuration of AR System 10]
[1-2. Configuration of Terminal Device 100 and Information Processing Device 200]
[1-3. Configuration of Server Device 300]
[1-4. Overall Processing of AR System 10]
[1-5. Processing in Information Processing Device 200]
<2. Modifications>

### 1. Embodiment

[1-1. Configuration of AR System 10]

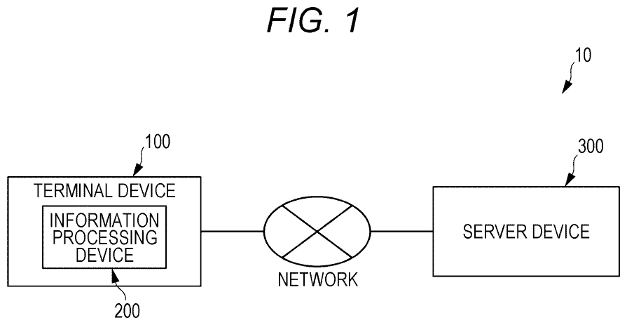

First, a configuration of an AR system 10 will be described with reference to FIG. 1. The AR system 10 includes a terminal device 100, an information processing device 200 operating on the terminal device 100, and a server device 300. The terminal device 100 and the server device 300 are connected via a network. The network may be wired or wireless.

The terminal device 100 is an AR device that includes at least a camera 106 and a display unit 105 and displays a virtual object for AR on an image captured by the camera 106 and displayed on the display unit 105. The terminal device 100 has a function as the information processing device 200 according to the present technology. Furthermore, the terminal device 100 includes a spatial information database 111, a first attribute information estimation unit 112 that performs attribute information estimation, an attribute information database 113 that stores attribute information, and a drawing unit 114 that draws a virtual object for AR on an image. The information processing device 200, the spatial information database 111, the first attribute information estimation unit 112, the attribute information database 113, and the drawing unit 114 will be described later. The terminal device 100 has a function as the information processing device 200, and does not need communication via a network for attribute information estimation, so that the attribute information can be estimated with a lower latency than the server device 300. However, since the processing speed of a central processing unit (CPU) of the terminal device 100 is usually slower than that of the server device 300, the attribute information is estimated at a lower frame rate than that of the server device 300.

The attribute information is semantic information associated with an object, such as a name, a meaning, an affordance, and a relationship between a plurality of objects of the object detected from the image captured by the camera 106. In order to display the virtual object for AR according to the attribute information of the object, it is necessary to estimate the attribute information for the object existing in the real space in units of pixels.

Note that the image may be a still image or a frame image constituting a video.

The server device 300 includes at least a second attribute information estimation unit 304, and estimates the attribute information similarly to the terminal device 100. The second attribute information estimation unit 304 will be described later. Since the server device 300 usually includes a CPU having a processing speed higher than that of the terminal device 100, the attribute information can be estimated at a higher frame rate than the terminal device 100. However, a latency increases due to communication between the terminal device 100 and the server device 300, resulting in high latency.

In the present technology, both the terminal device 100 and the server device 300 include an attribute information estimation unit. The information processing device 200 determines which one of the terminal device 100 and the server device 300 is to perform the attribute information estimation, and supplies an image and information necessary for the attribute information estimation to the device that performs the attribute information estimation.

### [1-2. Configuration of Terminal Device 100 and Information Processing Device 200]

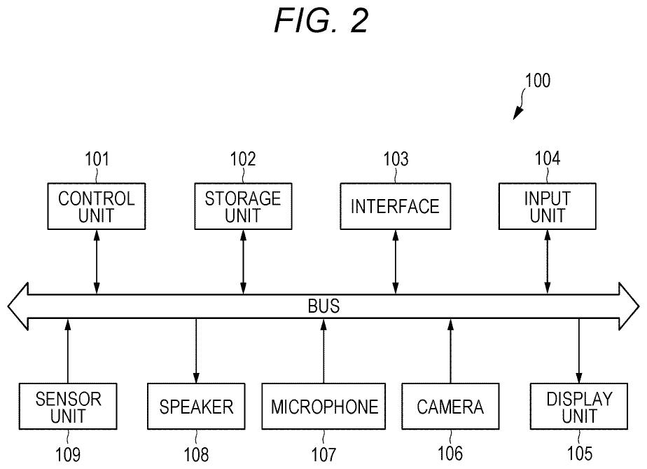

Next, configurations of the terminal device 100 and the information processing device 200 will be described. As illustrated in FIG. 2, the terminal device 100 includes at least a control unit 101, a storage unit 102, an interface 103, an input unit 104, a display unit 105, a camera 106, a microphone 107, a speaker 108, and a sensor unit 109.

The control unit 101 includes a CPU, a random access memory (RAM), a read only memory (ROM), and the like. The CPU executes various types of processing according to a program stored in the ROM and issues commands, thereby controlling an entire terminal device 100 and each unit thereof.

The storage unit 102 is, for example, a mass storage medium such as a hard disk or a flash memory. The storage unit 102 stores various applications, data, and the like used by the terminal device 100.

The interface 103 is an interface with the server device 300, the Internet, and the like. The interface 103 may include a wired or wireless communication interface. Furthermore, more specifically, the wired or wireless communication interface might include cellular communication such as 3TTE, Wi-Fi, Bluetooth (registered trademark), near field communication (NFC), Ethernet (registered trademark), high-definition multimedia interface (HDMI (registered trademark)), universal serial bus (USB) and the like. In addition, in a case where the terminal device 100 is implemented in a distributed manner on a plurality of devices, the interface 103 may include different types of interfaces for the respective devices. For example, the interface 103 may include both a communications interface and an interface in the terminal device 100.

The input unit 104 is used by the user to input information, give various instructions, and the like to the terminal device 100. When a user performs an input on the input unit 104, a control signal corresponding to the input is created and supplied to the control unit 101. Then, the control unit 101 performs various types of processing corresponding to the control signal. The input unit 104 includes, in addition to physical buttons, a touch panel, a touch screen integrally constructed with a monitor, and the like.

The display unit 105 is a display device such as a display that displays an image captured by the camera 106, an image in which a virtual object is drawn, a through image during operation of the camera 106, various contents, a UI of the terminal device 100, and the like.

The camera 106 includes a lens, an imaging element, a video signal processing circuit, and the like, and captures an image.

The microphone 107 is used by the user to input a voice to the terminal device 100 and collects a voice of the user and a surrounding voice.

The speaker 108 is a voice output device that outputs voice.

The sensor unit 109 includes a position sensor such as a global positioning system (GPS) that acquires a position of the terminal device 100, an angular velocity sensor that detects an orientation (imaging direction) of the camera 106 of the terminal device 100, a distance sensor such as light detection and ranging (LiDAR) that detects a distance to a target object, and the like. In the following description, various types of information acquired and output by the sensor unit 109 may be referred to as sensor information.

While the terminal device 100 is operating in the AR mode, the sensor unit 109 continues to acquire and output at least the position of the terminal device 100, the orientation (imaging direction) of the camera 106, the distance to an object existing in the imaging direction of the camera 106, and the like at predetermined time intervals.

The terminal device 100 is configured as described above. Specific examples of the terminal device 100 include a smartphone, a tablet terminal, a wearable device, a personal computer, a portable game machine, and the like. In a case where there is a program necessary for the processing according to the present technology, the program may be installed in the terminal device 100 or the terminal device 100 in advance, or may be distributed by download, a storage medium, or the like and installed by the user himself/herself.

Note that the camera 106, the microphone 107, the speaker 108, and the sensor unit 109 are not included in the terminal device 100 itself, and may be an external device connected to the terminal device 100 in a wired or wireless manner.

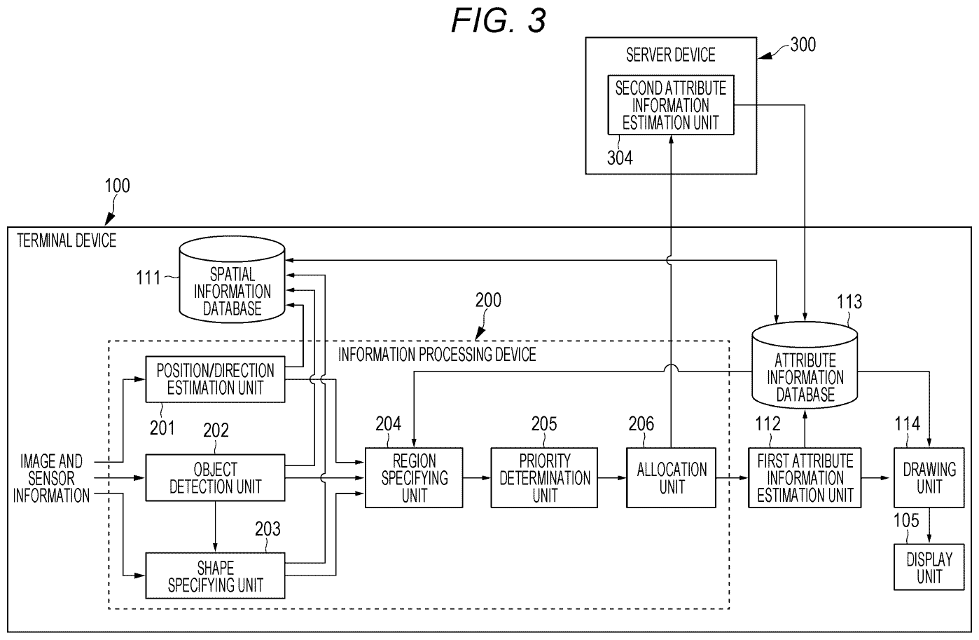

A configuration of the information processing device 200 will be described with reference to FIG. 3. Note that, for convenience of description, FIG. 3 also illustrates a part of the configurations of the terminal device 100 and the server device 300.

The information processing device 200 includes processing blocks of a position/direction estimation unit 201, an object detection unit 202, a shape specifying unit 203, a region specifying unit 204, a priority determination unit 205, and an allocation unit 206.

The position/direction estimation unit 201 estimates the position of the terminal device 100 on the basis of the sensor information. Furthermore, the position/direction estimation unit 201 estimates the direction (imaging direction) in which the camera 106 of the terminal device 100 faces on the basis of the sensor information. The position information and the orientation information, which are the estimation results of the position/direction estimation unit 201, are stored in the spatial information database 111. Note that the position/direction estimation unit 201 may be divided into a position estimation unit and a direction estimation unit.

The object detection unit 202 detects an object existing in an image captured by the camera 106 using a known object detection technology such as a method by machine learning or deep learning, a method by template matching, a matching method based on luminance distribution information of a subject, or a method using artificial intelligence, and specifies a type of the object (for example, an automobile, a person, a tree, and the like).

The shape specifying unit 203 models the object detected by the object detection unit 202 from the image in units of pixels using a known shape modeling technique such as a method by machine learning or deep learning, a method using artificial intelligence, or the like, and specifies the shape of the object. The shape information of the object is stored in the spatial information database 111.

The region specifying unit 204 specifies a region including the object detected by the object detection unit 202 in the image. The region specifying unit 204 specifies, for example, a rectangular region including the object, but the region is not limited to the rectangular shape, and may have another shape, for example, a circular shape, or a shape along the contour of the object.

The priority determination unit 205 determines priority of allocation by the allocation unit 206 for the region specified by the region specifying unit 204.

The allocation unit 206 determines which one of the terminal device 100 and the server device 300 performs the attribute information estimation for the region, cuts out the region from the image, and supplies the region to the first attribute information estimation unit 112 of the terminal device 100 or the second attribute information estimation unit 304 of the server device 300. A region cut out from the image is referred to as a region image. The region image is supplied to the first attribute information estimation unit 112 of the terminal device 100 via the internal bus or the internal network of the terminal device 100. In addition, the region image is supplied to the second attribute information estimation unit 304 of the server device 300 through a network such as the Internet using the interface of the terminal device 100 and the interface of the server device 300.

In a case where there is a plurality of regions in the image, the allocation unit 206 determines a device that performs attribute information estimation for the region in order of the priority determined by the priority determination unit 205. Details of this processing will be described later.

The information processing device 200 is configured as described above. The information processing device 200 may be realized by causing the terminal device 100 having a function as a computer to execute a program. The program may be installed in the terminal device 100 in advance, or may be distributed by downloading, a storage medium, or the like and installed by a user or the like.

The spatial information database 111 included in the terminal device 100 stores position information and orientation information which are estimation results of the position/direction estimation unit 201, shape information of an object specified by the shape specifying unit 203, and the like.

The first attribute information estimation unit 112 included in the terminal device 100 and the second attribute information estimation unit 304 included in the server device 300 estimate the attribute information of the object in the region on the basis of the supplied region image using a known attribute information estimation method such as a method based on machine learning, deep learning, or a method using artificial intelligence. The estimation of the attribute information can also be performed by a method described in the following document.
“Panoptic Fusion: Online Volumetric Semantic Mapping at the Level of Stuff and Things.” (G.
(G. Narita, T. Seno, T. Ishikawa, and Y. Kaji) [Online] http://arxiv.org/abs/1903.01177
“Mask R-CNN.” (K. He, G. Gkioxari, P. Dollar, and R. Girshick) [Online] http://arxiv.org/abs/1703.06870

Note that the first attribute information estimation unit 112 and the second attribute information estimation unit 304 may perform the attribute information estimation by the same method or may perform the attribute information estimation by different methods.

The estimation of the attribute information corresponds to specific processing in the claims. The control unit 101 may function as the first attribute information estimation unit 112 by execution of a program or the like, or the terminal device 100 may include an independent processing block of the first attribute information estimation unit 112.

The attribute information is stored in the attribute information database 113 in association with the region image for which the attribute information is estimated. Alternatively, the attribute information is stored in the attribute information database 113 in a state of being associated with the image and the information indicating the region in the image. The information indicating the region is information indicating the position and size of the region in the image, that is, information for specifying the region.

The attribute information database 113 included in the terminal device 100 is a database that stores the attribute information estimated by the first attribute information estimation unit 112 and the attribute information estimated by the second attribute information estimation unit 304 of the server device 300. The attribute information database 113 includes the storage unit 102 included in the terminal device 100. However, the terminal device 100 may include an attribute information database 113 independent of the storage unit 102.

The attribute information is stored in the attribute information database 113 in association with the position information and the orientation information of the terminal device 100 at the time of capturing the image, which is the target of the attribute information estimation, stored in the spatial information database 111. Since it is possible to specify where the camera 106 of the terminal device 100 has photographed by the position information and the orientation information of the terminal device 100 when the image is photographed, it is possible to refer to the past attribute information stored in the attribute information database 113 by using the position information and the orientation information.

The drawing unit 114 included in the terminal device 100 draws a virtual object for AR (various types of information by icons, characters, text, or the like) on an image displayed on the display unit 105 according to the attribute information. The image in which the virtual object is drawn is presented to the user by being displayed on the display unit 105. The control unit 101 may function as the drawing unit 114 by execution of a program or the like, or the terminal device 100 may include an independent processing block called the drawing unit 114.

Note that the information processing device 200 may have functions as the spatial information database 111, the first attribute information estimation unit 112, the attribute information database 113, and the drawing unit 114.

### [1-3. Configuration of Server Device 300]

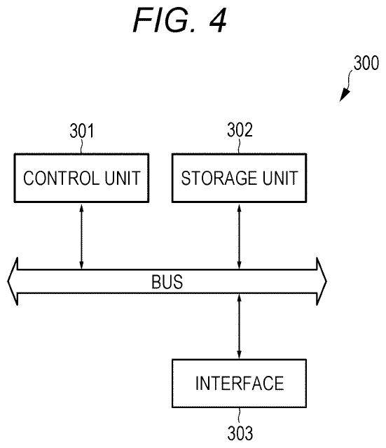

Next, a configuration of the server device 300 will be described with reference to FIG. 4. The server device 300 includes at least a control unit 301, a storage unit 302, and an interface 303. Since these are similar to those included in the terminal device 100 and the information processing device 200, the description thereof will be omitted.

The control unit 301 may function as the second attribute information estimation unit 304 by execution of a program or the like, or the server device 300 may include an independent processing block called the second attribute information estimation unit 304. Similarly to the first attribute information estimation unit 112 included in the terminal device 100, the second attribute information estimation unit 304 estimates the attribute information of the object in the region on the basis of the region image supplied from the allocation unit 206 of the information processing device 200. However, since the server device 300 includes a CPU having a higher processing speed than the terminal device 100, the attribute information can be estimated at a higher speed than the terminal device 100. However, the latency increases due to communication between the terminal device 100 and the server device 300. Note that the server device 300 may include an independent second attribute information estimation unit 304 different from the control unit 301.

### [1-4. Overall Processing of AR System 10]

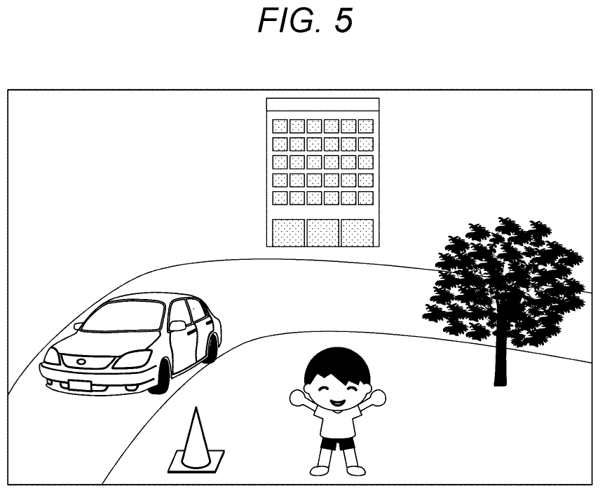

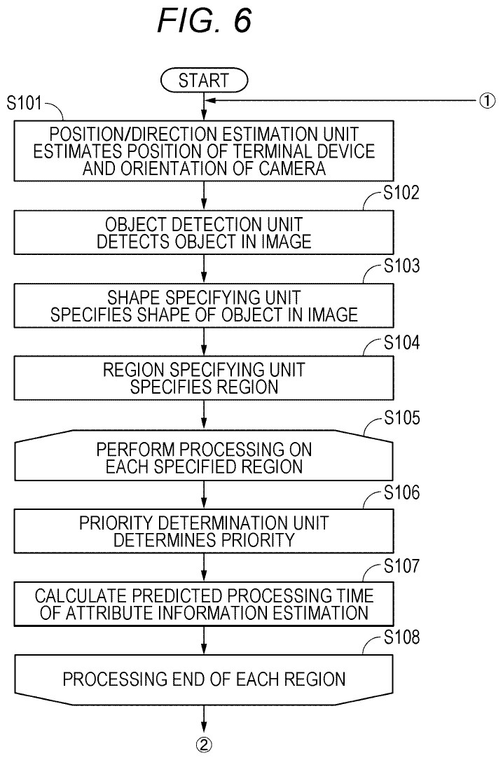

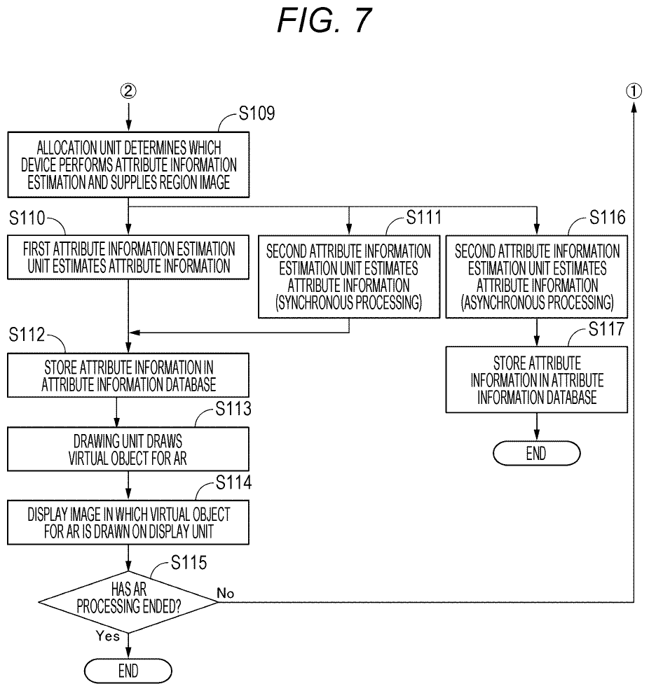

Next, overall processing of the AR system 10 will be described with reference to FIGS. 6 and 7. Here, the description will be given assuming that the image illustrated in FIG. 5 is an image captured by the camera 106.

First, in step S101, the position/direction estimation unit 201 estimates the position of the terminal device 100 on the basis of the sensor information. Furthermore, the position/direction estimation unit 201 estimates the orientation (imaging direction) of the camera 106 of the terminal device 100 on the basis of the sensor information. The position information and the orientation information of the terminal device 100 are stored in the spatial information database 111.

Next, in step S102, the object detection unit 202 detects an object from the image captured by the camera 106 and specifies the type of the object. In this description, it is assumed that objects such as a person, an automobile, a triangular cone, a tree, and a building are detected from the image illustrated in FIG. 5.

Next, in step S103, the shape specifying unit 203 models the shape of the object detected by the object detection unit 202. The shape information of the object is stored in the spatial information database 111 in association with the position information, the orientation information, and the attribute information.

Note that, step S101 may be performed after steps S102 and S103, or may be performed simultaneously or substantially simultaneously.

Next, in step S104, the region specifying unit 204 specifies a region including the object detected by the object detection unit 202 from the image. The region specifying unit 204 can specify the region so as to include the entire object. Furthermore, in a case where the shape of the latest object is changed as compared with the past shape of the same object, the region specifying unit 204 specifies a region including the object. Note that, at that time, the region may be specified so as to include both the shape before the change and the shape after the change according to the change in the shape of the object. Furthermore, a region in which the attribute information has been estimated in the past may be specified as a region in the latest processing. Furthermore, in a case where the attribute information has not been estimated for the object in the past, it can be seen that there is no attribute information for the object, and thus, it is preferable to specify the region so as to include the entire object.

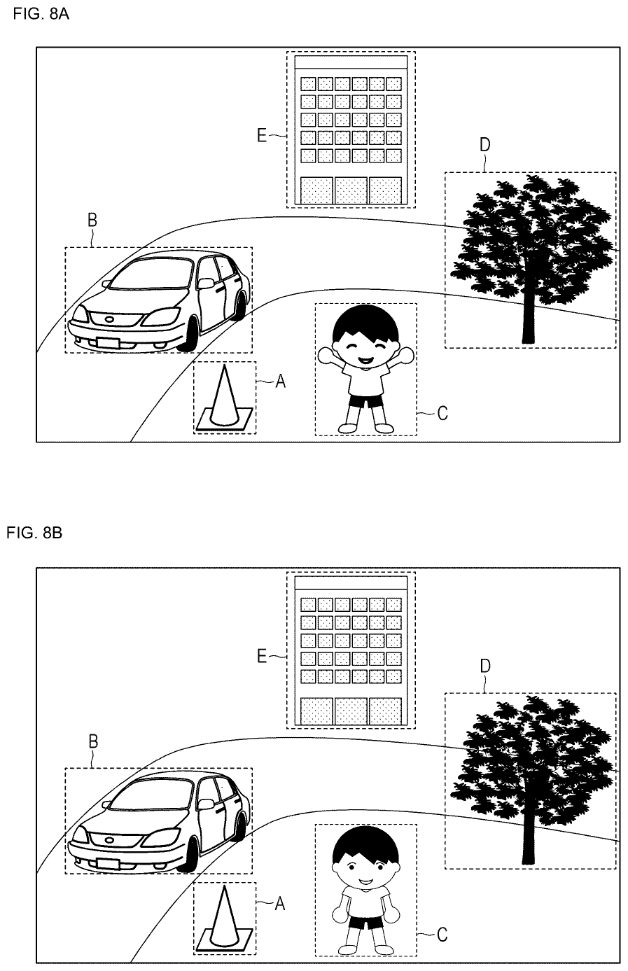

In the latest image illustrated in FIG. 5, regions A to E where a triangular cone, an automobile, a person, a tree, and a building exist are specified as indicated by rectangular regions of broken lines in FIG. 8A. Furthermore, the region specifying unit 204 specifies a region in the image that has not been specified as a region including the object as a background region.

Next, the processing of steps S105 to S108 is performed on each region.

First, in step S106, the priority determination unit 205 determines the priority for each region. Details of the priority determination will be described later.

Next, in step S107, a predicted processing time required for estimating the attribute information in each region is calculated. The processing time of the attribute information estimation is longer in proportion to the number of pixels to be processed regardless of the object. Therefore, the weight can be calculated by dividing the past processing time by the number of pixels to be processed, and the predicted processing time for the next and subsequent times can be calculated using the weight.

Next, in step S109, the allocation unit 206 determines a device that performs attribute information estimation for each region in the order of the priority determined by the priority determination unit 205. Then, the allocation unit 206 supplies the region image cut out from the image to a device that performs attribute information estimation.

In a case where the device that performs the attribute information estimation is the terminal device 100, the first attribute information estimation unit 112 estimates the attribute information for the region in step S110.

In addition, in a case where the device that performs the attribute information estimation is the server device 300 and the attribute information estimation is the synchronous processing, the second attribute information estimation unit 304 estimates the attribute information on the region by the synchronous processing in step S111. In a case where the attribute information is estimated by the second attribute information estimation unit 304, the server device 300 transmits the attribute information to the terminal device 100 via the network in order to store the attribute information in the attribute information database 113.

The synchronous processing means that the terminal device 100 and the server device 300 perform attribute information estimation and AR processing in synchronization with each other on the basis of a predetermined synchronization signal or the like. In a case where the estimation of the attribute information by the second attribute information estimation unit 304 is the synchronous processing, the terminal device 100 can use the attribute information estimated by the second attribute information estimation unit 304 for the real-time AR processing.

In a case where the attribute information is estimated by the first attribute information estimation unit 112 of the terminal device 100 and in a case where the attribute information is estimated by the synchronous processing by the second attribute information estimation unit 304 of the server device 300, the attribute information is then stored in the attribute information database 113 in step S112.

Next, in step S113, the drawing unit 114 draws a virtual object for AR on the image according to the attribute information.

Next, in step S114, the terminal device 100 displays the image in which the virtual object is drawn on the display unit 105. As a result, the user can view the image in which the virtual object is drawn.

Then, in step S115, it is confirmed whether or not the AR mode of the terminal device 100 has ended. In a case where the AR mode is ended, the entire processing is also ended (Yes in step S115). On the other hand, in a case where the AR processing has not been completed, the processing proceeds to step S101, and steps S101 to S113 are repeated (No in step S115). Whether or not the AR mode has ended can be confirmed, for example, by confirming whether or not the user has canceled the AR mode, whether or not the application using AR in the terminal device 100 has ended, or the like.

The description returns to step S109. After step S109, in a case where the device that performs the attribute information estimation is the server device 300 and the attribute information estimation is asynchronous processing, the second attribute information estimation unit 304 estimates the attribute information asynchronously with respect to the region in step S116.

Next, in step S117, the attribute information is asynchronously stored in the attribute information database 113. At this time, in a case where the attribute information of the same region is already stored in the attribute information database 113, the estimated time is overwritten with the new attribute information. In a case where the estimation of the attribute information is asynchronous, the estimation result cannot be used for the real-time AR processing, and thus the processing ends. Note that, in a case where the processing capability of the server device 300 is low (the processing speed is equal to or less than a predetermined value), asynchronous attribute information estimation in the server device 300 may not be performed. As a result, the processing load of the server device 300 can be reduced.

The entire processing of the AR system 10 is performed as described above.

### [1-5. Processing in Information Processing Device 200]

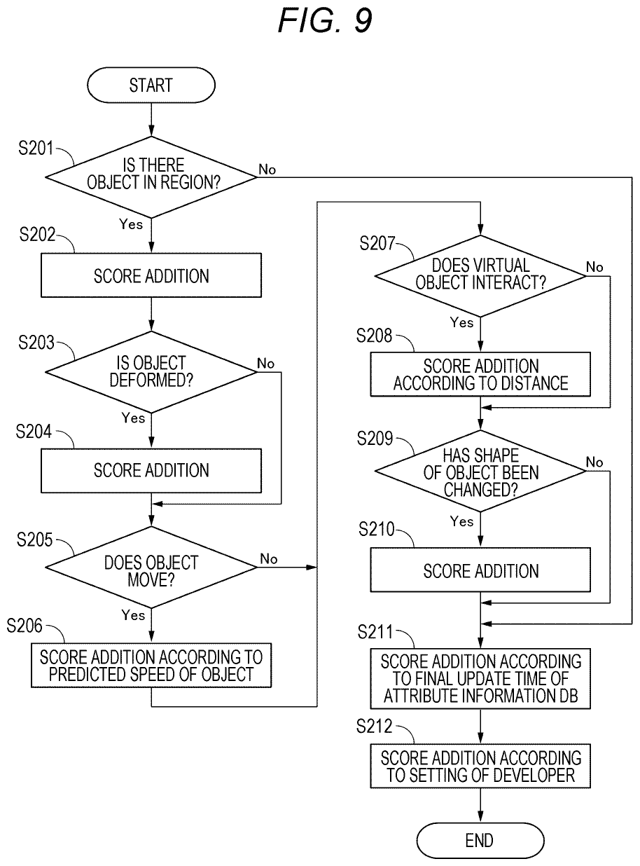

Next, processing in the information processing device 200 will be described. First, processing by the priority determination unit 205 will be described with reference to FIG. 9. The processing by the priority determination unit 205 is performed for each region specified in the image, and is finally performed for all the regions.

The priority is determined by adding scores according to whether the region satisfies a predetermined condition and summing the final scores.

First, in a case where there is an object detected by the object detection unit 202 in the region in step S201, the processing proceeds to step S202, and the score is added for the region (Yes in step S201).

Next, in step S203, it is determined whether or not the object in the region is deformed. In a case where the object is deformed, the processing proceeds to step S204, and the score is added for the region (Yes in step S203). In a case where the object is not deformed, the estimation result of the attribute information performed on the region where the object exists in the past can be diverted. However, in a case where the object is deformed, the region may change with time, and thus the attribute information estimated in the past cannot be diverted. Therefore, it is necessary to estimate the attribute information again, and it is preferable to estimate the attribute information in the terminal device 100 capable of estimating the attribute information at a low frame rate but with a low latency. Therefore, in a case where the object is deformed, a score is added to increase the priority of the region including the object. For example, a score is added on the assumption that a tree is an object that deforms in a case where the tree is shaken by wind or the like, and a score is not added on the assumption that a building is a rigid body and is not deformed.

Whether or not the object is deformed can be determined, for example, by preparing a table in which types of a plurality of objects are associated with whether or not the object is deformed in advance, and referring to the table on the basis of the type of the object detected by the object detection unit 202.

Note that the attribute information estimated in the past can be obtained by referring to the attribute information database 113 on the basis of the position information and the orientation information estimated by the position/direction estimation unit 201. This is because it is possible to specify where the camera 106 of the terminal device 100 has imaged by the position information and the orientation information, and thus it is possible to estimate that there is the same object in a case where the same orientation is imaged at the same position. Note that the attribute information estimated in the past can be used only in a case where the object is a still object.

In addition, in step S205, it is determined whether or not the object in the region moves. In a case where the object moves, the processing proceeds to step S206, and the score is added according to the predicted moving speed of the object (Yes in step S205).

In a case where the object does not move, the estimation result of the attribute information performed on the region where the object exists in the past can be diverted, but in a case where the object moves, the region may change with the lapse of time, and thus the attribute information estimated in the past cannot be diverted. Therefore, it is necessary to estimate the attribute information again, and it is preferable to estimate the attribute information in the terminal device 100 capable of estimating the attribute information at a low frame rate but with a low latency. Therefore, in a case where the object moves, a score is added in order to increase the priority of the region including the object. For example, the score is added on the assumption that a person or an automobile is a moving object, and the score is not added on the assumption that a building, a triangular cone, or a tree is an object that does not move.

Whether or not the object moves can be determined, for example, by preparing a table in which types of a plurality of objects are associated with whether the object is movable or immovable in advance, and referring to the table on the basis of the type of the object detected by the object detection unit 202.

Furthermore, in step S207, it is determined whether or not the virtual object for AR drawn in the image corresponding to the object in the region interacts with the user. In a case where the virtual object interacts with the user, the processing proceeds to step S208, and the score is added according to the distance between the user and the object in the region (Yes in step S207).

Specifically, in a case where the distance between the user and the object in the region is within a predetermined distance (in a case where the user and the virtual object are close), more scores are added than in a case where the distance between the user and the object in the region is a predetermined distance or more (in a case where the user and the virtual object are far). In a case where the user and the virtual object are close to each other, it is preferable to perform the attribute information estimation by the terminal device 100 capable of performing the attribute information estimation at a low frame rate but with a low latency. Therefore, in a case where the user and the virtual object are close to each other, a score is added to increase the priority. The distance between the user and the object can be obtained by a distance sensor in the sensor unit 109.

Note that “the virtual object interacts with the user” means, for example, that a virtual object for AR (character or the like) drawn corresponding to an object talks to the user, interacts with the user, or the like.

The determination in step S207 can be performed, for example, by preparing a table in which types of a plurality of objects and whether or not a virtual object drawn corresponding to the object interacts with the user are associated in advance, and referring to the table on the basis of the type of the object detected by the object detection unit 202.

In addition, in step S209, it is determined whether the shape of the object in the region has changed. This determination can be made by comparing the latest shape of the object with the past shape of the object. In a case where the shape of the object has changed, the processing proceeds to step S210, and the score is added for the region (Yes in step S209).

As described above, the shape information of the object obtained by the shape specifying unit 203 is stored in the spatial information database 111 in association with the position information and the orientation information. Therefore, the past shape of the object can be obtained by referring to the shape information of the same object whose storage time is in the past stored in the spatial information database 111 on the basis of the position information and the orientation information.

The change in the shape of the object includes not only a case where the shape itself of the object changes but also a case where another object existing in front of the object moves and a portion hidden by the other object becomes visible. For example, there is a case where, in the past, a part of a tree is hidden by an automobile due to an automobile in front of the tree, but thereafter, a part of the tree hidden by the automobile becomes visible from the position of the user due to movement of the automobile.

Note that the determination processing in step S203, step S205, step S207, and step S209 do not necessarily need to be performed in the order illustrated in FIG. ?.

Next, in step S211, a score is added according to whether or not the attribute information has been estimated for the region in the past. A case where the attribute information has never been estimated in the past is maximized, and a larger value is added to the score as the past attribute information estimation time is older. This is because there is a higher possibility that the final estimation time deviates from the current state as the final estimation time is older, and thus the attribute information estimation should be preferentially performed by adding the score.

Next, in step S212, in a case where the developer has set the score to be added to the specific object in advance, and the object in the region is the specific object, the score is added. For example, in a case where the developer intends to draw a castle as a virtual object for AR on a building, and it is preferable to perform attribute information estimation with low latency, the attribute information is added to the score so that the priority of the building increases in order to perform the attribute information estimation by the terminal device 100. In addition, in a case where it is preferable to perform the attribute information estimation at a high frame rate, the score is not added so that the priority of the building does not increase in order to perform the attribute information estimation by the server device 300.

The determination in step S212 can be performed, for example, by preparing a table in which types of a plurality of objects and objects set by the developer to add a score to a specific object are associated in advance, and referring to the table on the basis of the type of the object detected by the object detection unit 202.

Scoring is performed on the object in the region as described above.

Here, it is assumed that +1 is added to the score in the case of simply “adding the score”, and that a value is added to the score according to each condition in the case of adding to the score in steps S206, S208, and S211.

Here, an example of the latest image illustrated in FIG. 8A and the past image illustrated in FIG. 8B will be described as to how the score is added to each region in the latest image. Note that it is assumed that the attribute information of each region in the past image of FIG. 8B has been estimated in the past.

Since a triangular cone exists in the region A, +1 is added to the score in step S202. In addition, since the attribute information has been estimated for the same triangular cone in the past, +1 is added to the score in step S211. As a result, the score of the region A is “+2” in total.

In addition, since an automobile exists in the region B, +1 is added to the score in step S202. In addition, since the automobile is a moving object, the score is added in step S206, but since the automobile is faster than the person in moving speed, +4 is added to the score according to the expected speed. The value of +4 is merely an example. In addition, since the attribute information has been estimated for the same automobile in the past, +1 is added to the score in step S211. As a result, the score of the region B is “+6” in total.

In addition, in the region C, since a person exists in the region, +1 is added to the score in step S202. In addition, since the person is a deformable object, +1 is added to the score in step S204. In addition, since the person is a moving object, +1 is added to the score in step S206. In addition, since the shape has changed as compared with the past, +1 is added to the score in step S210. Furthermore, since the attribute information has been estimated for the same person in the past, +1 is added to the score in step S211. As a result, the score of the region C is “+5” in total.

In the region D, since a tree exists in the region, +1 is added to the score in step S202. In addition, since the tree is a deformable object, +1 is added to the score in step S204. In addition, since the attribute information has been estimated in the past, +1 is added to the score. As a result, the total score of the region where the tree exists is “+3”.

In the region E, since a building exists in the region, +1 is added to the score in step S202. In addition, since the attribute information has been estimated in the past, +1 is added to the score. As a result, the total score of the region where the building exists “+2”.

Furthermore, since there is no object in the background region, the score is “0” in total.

As a result of this scoring, when the priority is determined in descending order of the total score, the order of the priority is the region B (automobile), the region C (person), the region D (tree), the region A (triangular cone), the region E (building), and the background region. Note that the order of the score and the priority is described merely as an example of description, and these objects do not always have such a score or priority.

The processing by the priority determination unit 205 is performed as described above.

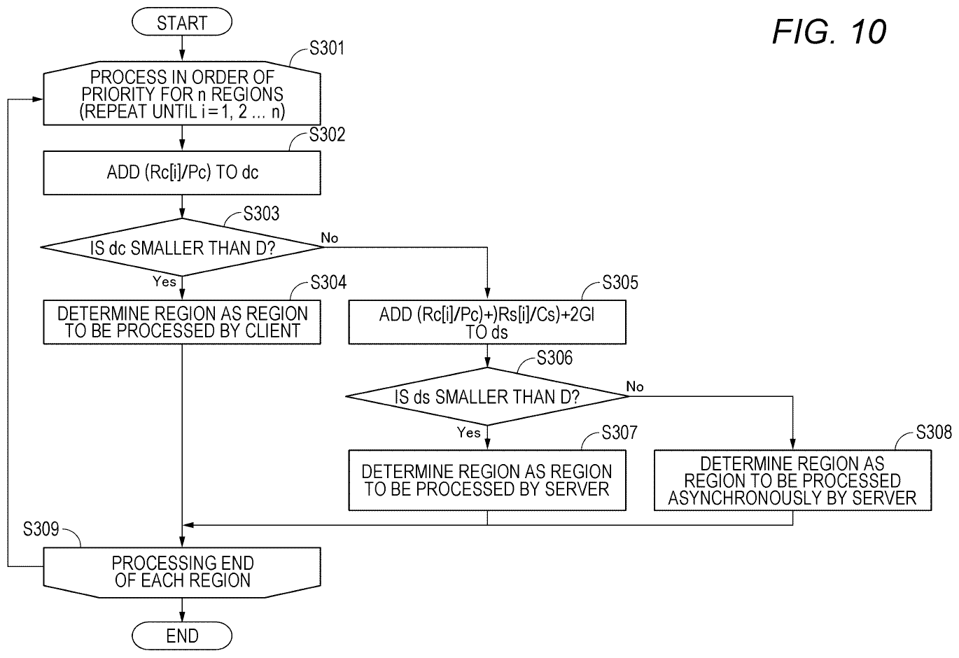

Next, processing by the allocation unit 206 will be described with reference to FIG. 10. The processing by the allocation unit 206 is sequentially performed from the region with the higher priority, and is finally performed for all the regions.

Parameters used for processing by the allocation unit 206 are defined as follows.
i: Order of priority
dc: Variable
ds: Variable
D: Remaining time until process shifts from first attribute information estimation unit 112 to drawing unit 114 in terminal device 100
Pc: Processing capability per unit time of terminal device 100
Ps: Processing capability per unit time of server device 300
Cs: Communication speed between terminal device 100 and server device 300
Cl: Latency between terminal device 100 and server device 300 (one way)
Rc: Calculation amount required for attribute information estimation
Rc [i]: Calculation amount required for estimating attribute information of i-th region in priority
Rs [i]: Image capacity of i-th region in priority

As illustrated in step S301, the processing by the allocation unit 206 is performed on a plurality of (n) regions specified in the image in order of priority, and is repeated from a region with a first priority to a region with an n-th priority. Therefore, in the example of FIG. 8, first, processing is performed on the region B (automobile) having the first priority. Next, processing is performed on the region C (person) having the second priority. Next, processing is performed on the region D (tree) having the third priority. Next, processing is performed on the region A (triangular cone) having the fourth priority is processed. Next, processing is performed on the region E (building) having the fifth priority. Next, processing is performed on the background region having the sixth priority. First, in step S302, a value calculated by the following Formula 1 is added to the variable dc.

Rc[i]/Pc [Formula 1]

The value calculated by Formula 1 is the time required for the terminal device 100 to complete the attribute information estimation for the i-th region in the priority. Note that the calculation amount Rc required for estimating the attribute information of the region can be calculated, for example, by multiplying the area of the region by a predetermined coefficient. However, the calculation method of the calculation amount Rc is not limited thereto, and the calculation amount Rc may be calculated by another method.

In the first cycle of processing, first, the value calculated by Formula 1 is added to the variable dc for the region with the first priority.

Next, in step S303, the variable dc after the addition is compared with the remaining time D (hereinafter, referred to as remaining time D) until the process shifts from the attribute information estimation unit to the drawing unit 114 in the terminal device 100.

As a result of comparing the variable dc with the remaining time D, in a case where the variable dc is smaller than the remaining time D, the processing proceeds to step S304 (Yes in step S303).

Then, in step S304, a region with a first priority is determined as a region to be processed by the attribute information estimation unit of the terminal device 100. Since what is calculated by the above-described Formula 1 is the time required for the terminal device 100 to complete the attribute information estimation for the region, the case where the variable dc is smaller than the remaining time D is the case where the terminal device 100 can estimate the attribute information. Therefore, in a case where the variable dc is smaller than the time D, the region is determined as the region where the attribute information estimation is performed by the terminal device 100.

On the other hand, in a case where the variable dc is larger than the remaining time D in step S303, the processing proceeds to step S305 (No in step S303). The case where the variable dc is larger than the remaining time D is a case where the time required for the terminal device 100 to complete the attribute information estimation for the region is larger than the remaining time D until the process shifts from the first attribute information estimation unit 112 to the drawing unit 114 in the terminal device 100. In this case, it is not appropriate to estimate the attribute information in the terminal device 100.

Next, in step S305, a value calculated by the following Formula 2 is added to the variable ds. What is calculated by Formula 2 is the time required for the second attribute information estimation unit 304 of the server device 300 to complete the attribute information estimation for the i-th region in priority.

(Rc[i]/Ps)+(Rs[i]/Cs)+2Cl [Formula 2]

In the first cycle of processing, first, the value calculated by Formula 2 is added to the variable ds for the region with the first priority.

Next, in step S306, the variable ds is compared with the remaining time D, and in a case where the variable ds is smaller than the remaining time D, the processing proceeds to step S307 (Yes in step S306).

Then, in step S307, a region having a first priority is determined as a region to be processed by the synchronous processing in the second attribute information estimation unit 304 of the server device 300. Since what is calculated by Formula 2 described above is the time required for the server device 300 to complete the attribute information estimation for the region, the case where the variable ds is smaller than the remaining time D is a case where the server device 300 can estimate the attribute information. Therefore, in a case where the variable ds is smaller than the remaining time D, the region is determined as the region where the attribute information is estimated by the server device 300.

On the other hand, in a case where the variable ds is larger than the time D in step S306, the processing proceeds to step S308 (No in step S306).

Then, in step S308, a region having a first priority is determined as a region to be processed asynchronously in the attribute information estimation unit of the server device 300.

In a case where the variable ds is larger than the time D in step S306, it is considered that the estimation of the attribute information is not completed in both the terminal device 100 and the server device 300 until the process shifts to the drawing unit 114 in the terminal device 100. Therefore, in that case, the attribute information is estimated by asynchronous processing in the server device 300 so that the attribute information can be used in subsequent processing of the drawing unit 114. Therefore, the estimation result of the attribute information in this case is not used for the real-time AR processing, and the attribute information is asynchronously stored in the attribute information database 113 as soon as the estimation is completed.

As described above, the processing of FIG. 10 is performed on the n regions specified in the image in order of priority, and is repeated from the region with the first priority to the region with the n-th priority. Therefore, when the processing for the region with the first priority is completed, the processing for the region with the second priority is performed next (processing is performed with i=2).

Since the variable dc is a common variable regardless of the region, the processing is repeated in order of priority, and the value increases each time the value is added in step S302. It similarly applies to the variable ds.

In step S302 for the region with the second priority, “Rc [2]/Pc” calculated by Formula 1 is further added to dc obtained by adding the value calculated by Formula 1 in the processing for the region with the first priority. It similarly applies to the addition to the variable ds in step S305.

Furthermore, when the processing for the region with the second priority is completed, the processing for the region with the third priority is performed next (processing is performed with i=3). Next, processing is performed on the region with the fourth priority (processing is performed with i=4). Next, processing is performed on the region with the fifth priority (processing is performed with i=5). In this manner, steps S301 to S308 are repeated until the processing is completed for all the regions in the image.

Assuming that the priority order of the region when the variable dc becomes larger than the remaining time D in the comparison in step S303 is Ic, the first to (Ic−1) th regions in the priority order are determined as the regions to be processed by the terminal device 100.

In addition, assuming that Is is the priority order of the region when the variable ds becomes larger than the remaining time D in the comparison in step S306, the Ic-th to (Is−1) th priority orders are determined as the regions to be processed by the server device 300.

In the example of the image illustrated in FIG. 8, for example, it is assumed that Ic is 3 and Is is 5. In this case, the region B (automobile) having the first priority and the region C (person) having the second priority are determined as the regions in which the attribute information is estimated by the terminal device 100.

In addition, the region D (tree) having the third priority and the region A (triangular cone) having the fourth priority are determined as the regions in which the attribute information is estimated by the synchronous processing in the server device 300.

Furthermore, the region E (building) and the background region, which are the regions with the priorities of Is to n, are determined as the regions in which the attribute information is estimated by the asynchronous processing in the server device 300.

Then, when determining a device that performs attribute information estimation for all the regions, the allocation unit 206 supplies a region image obtained by cutting out the region from the image to the device that performs attribute information estimation. Note that, in a case where the communication speed of the network between the terminal device 100 and the server device 300 is a predetermined value or more, that is, in a case where the communication speed is sufficiently high, the allocation unit 206 may supply the entire image and information indicating the position and size of the region in the image to the server device 300 that performs the attribute information estimation. The server device 300 specifies the region from the entire image on the basis of the information indicating the position and size of the region and estimates the attribute information. It is considered that the accuracy of the attribute information estimation can be enhanced by supplying not only the region image but also the entire image to the server device 300.

The processing by the information processing device 200 is performed as described above. According to the present technology, estimation of attribute information for a plurality of regions is performed by allocating the attribute information to the terminal device 100 and the server device 300. As a result, even in a case where processing cannot be performed by only one of the terminal device 100 and the server device 300, it is possible to efficiently estimate the attribute information and complete the processing. As a result, the real-time property of the AR processing using the estimation result of the attribute information can be improved.

Furthermore, in a case where processing is performed by the terminal device 100, the attribute information estimation can be performed at a high frame rate and a low latency. Furthermore, in a case where processing is performed by the server device 300, the attribute information estimation can be performed at a high frame rate.

### 2. Modifications

Although the embodiment of the present technology has been specifically described above, the present technology is not limited to the above-described embodiment, and various modifications based on the technical idea of the present technology are possible.

In the embodiment, the AR system 10 is configured by one terminal device 100 and one server device 300, but the AR system 10 may be configured by one terminal device 100 and a plurality of server devices 300, may be configured by a plurality of terminal devices 100 and one server device 300, or may be configured by a plurality of terminal devices 100 and a plurality of server devices 300.

In the embodiment, there is one terminal device 100 and one server device 300, and the attribute information estimation is allocated to the terminal device 100 and the server device 300. However, there may be a plurality of server devices 300, and the attribute information estimation may be allocated to any one of the plurality of server devices 300, or the attribute information estimation may be allocated to the terminal device 100 and the plurality of server devices 300.

In addition, the spatial information database 111, the attribute information database 113, and the drawing unit 114 may be included in the server device 300, or may be included in both the terminal device 100 and the server device 300.

In the embodiment, the description has been given assuming that the specific processing is the estimation of the attribute information, but the specific processing is not limited thereto. For example, the specific processing may be processing of processing an object in the region (changing shape, changing color, or the like) or processing of generating a composite image, or may be any processing as long as it is processing related to an image.

The present technology may also have the following configurations.
(1)

An information processing device including:
a region specifying unit that specifies a plurality of regions each including each of a plurality of objects detected from an image; and
an allocation unit that allocates specific processing to be performed on each of the plurality of regions to a plurality of devices.
(2)

The information processing device according to (1), in which the allocation unit determines a device to which the specific processing is allocated on the basis of a calculation amount required for the specific processing.
(3)

The information processing device according to (2), in which the allocation unit calculates the calculation amount required for the specific processing from an area of the region.
(4)

The information processing device according to (2) or (3), in which the allocation unit determines a device to which the specific processing is allocated on the basis of the calculation amount and a remaining time until the device transitions from the specific processing to next processing.
(5)

The information processing device according to any one of (1) to (4), further including a priority determination unit that determines a priority of allocating a device that performs the specific processing by the allocation unit for the plurality of regions.
(6)

The information processing device according to (5), in which the priority determination unit determines the priority on the basis of whether or not the object is deformed.
(7)

The information processing device according to (5) or (6), in which the priority determination unit determines the priority on the basis of whether or not the object moves.
(8)

The information processing device according to any one of (5) to (7), in which the priority determination unit determines the priority on the basis of whether or not a shape of the object has changed.
(9)

The information processing device according to any one of (5) to (8), in which the priority determination unit determines the priority on the basis of whether or not a virtual object for AR displayed corresponding to the object interacts with a user.
(10)

The information processing device according to any one of (5) to (9), in which the priority determination unit determines the priority on the basis of a time when the specific processing has been performed on the region in a past.
(11)

The information processing device according to any one of (1) to (10), in which the region cut out from the image is supplied to the device that performs the specific processing.
(12)

The information processing device according to any one of (1) to (11), in which the image and information indicating the region are supplied to the device that performs the specific processing.
(13)

The information processing device according to any one of (1) to (12), in which the specific processing is estimation of attribute information on the object.
(14)

The information processing device according to any one of (1) to (13), in which the plurality of devices includes a first device and a second device, and the first device is a device having a function of an information processing device.
(15)

The information processing device according to (14), in which the first device is an AR device.
(16)

The information processing device according to (14), in which the second device can perform processing at a higher speed than the first device.
(17)

The information processing device according to (16), in which the second device is a server device.
(18)

An information processing method including:
specifying a plurality of regions each including each of a plurality of objects detected from an image; and
allocating specific processing to be performed on each of the plurality of regions to a plurality of devices.
(19)

A program for causing a computer to execute an information processing method including:
specifying a plurality of regions each including each of a plurality of objects detected from an image; and
allocating specific processing to be performed on each of the plurality of regions to a plurality of devices.

### REFERENCE SIGNS LIST

100 Terminal device
200 Information processing device
204 Region specifying unit
205 Priority determination unit
206 Allocation unit
300 Server device

1. An information processing device comprising:
a region specifying unit that specifies a plurality of regions each including each of a plurality of objects detected from an image; and
an allocation unit that allocates specific processing to be performed on each of the plurality of regions to a plurality of devices.

2. The information processing device according to claim 1, wherein
the allocation unit determines a device to which the specific processing is allocated on a basis of a calculation amount required for the specific processing.

3. The information processing device according to claim 2, wherein
the allocation unit calculates the calculation amount required for the specific processing from an area of the region.

4. The information processing device according to claim 2, wherein
the allocation unit determines a device to which the specific processing is allocated on a basis of the calculation amount and a remaining time until the device transitions from the specific processing to next processing.

5. The information processing device according to claim 1, further comprising
a priority determination unit that determines a priority of allocating a device that performs the specific processing by the allocation unit for the plurality of regions.

6. The information processing device according to claim 5, wherein
the priority determination unit determines the priority on a basis of whether or not the object is deformed.

7. The information processing device according to claim 5, wherein
the priority determination unit determines the priority on a basis of whether or not the object moves.

8. The information processing device according to claim 5, wherein
the priority determination unit determines the priority on a basis of whether or not a shape of the object has changed.

9. The information processing device according to claim 5, wherein
the priority determination unit determines the priority on a basis of whether or not a virtual object for AR displayed corresponding to the object interacts with a user.

10. The information processing device according to claim 5, wherein
the priority determination unit determines the priority on a basis of a time when the specific processing has been performed on the region in a past.

11. The information processing device according to claim 1, wherein
the region cut out from the image is supplied to the device that performs the specific processing.

12. The information processing device according to claim 1, wherein
the image and information indicating the region are supplied to the device that performs the specific processing.

13. The information processing device according to claim 1, wherein
the specific processing is estimation of attribute information on the object.

14. The information processing device according to claim 1, wherein
the plurality of devices includes a first device and a second device, and the first device is a device having a function of an information processing device.

15. The information processing device according to claim 14, wherein
the first device is an AR device.

16. The information processing device according to claim 14, wherein
the second device can perform processing at a higher speed than the first device.

17. The information processing device according to claim 16, wherein
the second device is a server device.

18. An information processing method comprising:
specifying a plurality of regions each including each of a plurality of objects detected from an image; and
allocating specific processing to be performed on each of the plurality of regions to a plurality of devices.

19. A program for causing a computer to execute an information processing method comprising:
specifying a plurality of regions each including each of a plurality of objects detected from an image; and
allocating specific processing to be performed on each of the plurality of regions to a plurality of devices.
